(19) United States
(12) Patent Application Publication
(10) Pub. No.: US 2024/0196895 A1
(43) Pub. Date: Jun. 20, 2024

(54) FORMULATION

(71) Applicant: SYNGENTA CROP PROTECTION AG, Basel (CH)

(72) Inventors: Jean-Charles Daniel Nicolas BROQUET, Bracknell, Berkshire (GB); Jenny TELLIS, Bracknell, Berkshire (GB)

(73) Assignee: SYNGENTA CROP PROTECTION AG, Basel (CH)

(21) Appl. No.: 18/553,480

(22) PCT Filed: Mar. 25, 2022
(86) PCT No.: PCT/EP2022/057974

§ 371 Date: Sep. 29, 2023

(30) Foreign Application Priority Data
Mar. 30, 2021 (EP) 21165760.6

(51) Int. Cl. A01N 43/40; A01N 25/02; A01N 37/18; A01N 37/22; A01P 3/00

(52) U.S. Cl. CPC A01N 43/40; A01N 25/02; A01N 37/18; A01N 37/22; A01P 3/00

(57) ABSTRACT

This invention relates to a fungicidal composition comprising: a. oxathiapiprolin, b. metalaxyl-M, and c. a lactamide compound of formula I CH₃CH(OH)C(═O)NR₁R₂ (I) wherein R₁ and R₂ are each independently hydrogen; or C₁₋₆ alkyl, C₂₋₆ alkenyl or C₃₋₆ cycloalkyl, each of which is optionally substituted by up to three substituents independently selected from phenyl, hydroxy, C₁₋₅ alkoxy, morpholinyl and NR₃R₄ where R₃ and R₄ are each independently C₁₋₃ alkyl; or phenyl optionally substituted by up to three substituents independently selected from C₁₋₃ alkyl; or R₁ and R₂ together with the nitrogen atom to which they are attached form a morpholinyl, pyrrolidinyl, piperidinyl or azepanyl ring, each of which is optionally substituted by up to three substituents independently selected from C₁₋₃ alkyl, the composition comprising at least 40% by weight of said lactamide compound, over the total weight of the composition.

This invention relates to a composition comprising oxathiapiprolin and metalaxyl-M. More particularly, this invention relates to formulations such as dispersible concentrates (DC) or emulsifiable concentrates (EC); to dilutions or dispersions of such formulations more particularly in a farmer's spray-tank; and to use of such a composition in agriculture or horticulture for controlling or preventing infestation of plants by phytopathogenic microorganisms, preferably fungi.

Oxathiapiprolin and metalaxyl-M are both fungicidal agrochemicals. However, it has been found that with such active ingredients mixture, conventional formulation approaches present a number of problems, such as for example formulations are difficult to make with a satisfying stability over time, and when the amount of active ingredients is increased, toxicity becomes more complex to deal with.

The aim of the present invention is to overcome the problems of the prior art techniques by proposing a composition comprising oxathiapiprolin and metalaxyl-M, guaranteeing a temperature stability when exposed to changing temperatures, while reducing toxicity of the active ingredients in said mixture.

To this end, an object of the present invention is to provide a composition comprising:
(a) oxathiapiprolin,
(b) metalaxyl-M, and
(c) a lactamide compound of formula I

CH₃CH(OH)C(═O)NR₁R₂ (I)
wherein R₁ and R₂ are each independently hydrogen; or C₁₋₆ alkyl, C₂₋₆ alkenyl or C₃₋₆ cycloalkyl, each of which is optionally substituted by up to three substituents independently selected from phenyl, hydroxy, C₁₋₅ alkoxy, morpholinyl and NR₃R₄ where R₃ and R₄ are each independently C₁₋₃ alkyl; or phenyl optionally substituted by up to three substituents independently selected from C₁₋₃ alkyl; or R₁ and R₂ together with the nitrogen atom to which they are attached form a morpholinyl, pyrrolidinyl, piperidinyl or azepanyl ring, each of which is optionally substituted by up to three substituents independently selected from C₁₋₃ alkyl,
the composition comprising at least 40% by weight of said lactamide compound, preferably at least 50% by weight of said lactamide compound, and more preferably at least 60% by weight of said lactamide compound, over the total weight of the composition.

Thanks to the combination of (a), (b) and (c), all the above problems have been overcome. More particularly, the present invention guarantees a temperature stability, especially at cold temperature (−10° C.), while providing a low toxicity such as decreasing eye irritancy, especially in view of a high loading of active ingredients. The composition of the present invention is thus easy to store even at low temperature and valuable if contact with either human or animal eyes may occur by accident.

The composition of the present invention comprises at least two different active ingredients, which are oxathiapiprolin and metalaxyl-M, both being fungicide. Hence, the present composition is more particularly a fungicidal composition.

Oxathiapiprolin is a fungicide with the following CAS number: 1003318-67-9, and has the following chemical formula:

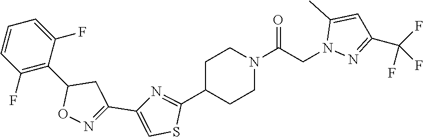 [SMILES: Cc1cc(C(F)(F)F)nn1CC(=O)N1CCC(c2nc(C3=NOC(c4c(F)cccc4F)C3)cs2)CC1]

Metalaxyl-M is a fungicide with the following CAS number: 70630-17-0, also well-known under the name of Mefenoxam, and has the following chemical formula:

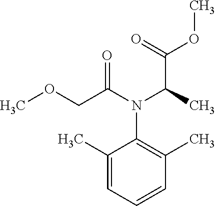

The present invention can have a high amount of active ingredients, especially a high amount of metalaxyl-M. More particularly, the composition can comprise at least 5% by weight of metalaxyl-M, preferably at least 6% by weight of metalaxyl-M, preferably at least 8% by weight of metalaxyl-M, preferably at least 10% by weight of metalaxyl-M, preferably at least 12% by weight of metalaxyl-M, and more preferably at least 15% by weight of metalaxyl-M, over the total weight of the composition.

This lower limit of metalaxyl-M can advantageously optimize the temperature stability of the composition, especially at cold temperature (−10° C.).

The composition of the present invention can comprise up to 10% by weight of oxathiapiprolin, and preferably up to 5% by weight of oxathiapiprolin, over the total weight of the composition. More preferably, the composition can comprise from 1% to 10% by weight of oxathiapiprolin, and preferably from 1% to 5% by weight of oxathiapiprolin, over the total weight of the composition.

More particularly, the composition according to the present invention can comprise:
(a) up to 10% by weight of oxathiapiprolin, and preferably up to 5% by weight of oxathiapiprolin, over the total weight of the composition,
(b) at least 5% by weight of metalaxyl-M, preferably at least 6% by weight of metalaxyl-M, preferably at least 8% by weight of metalaxyl-M, preferably at least 10% by weight of metalaxyl-M, preferably at least 12% by weight of metalaxyl-M, and more preferably at least 15% by weight of metalaxyl-M, over the total weight of the composition, and
(c) at least 40% by weight of said lactamide compound, over the total weight of the composition.

In a preferred embodiment, the composition can comprise:
(a) from 1% to 10% by weight of oxathiapiprolin, and preferably from 1% to 5% by weight of oxathiapiprolin, over the total weight of the composition,
(b) from 5% to 30% by weight of metalaxyl-M, and preferably from 10% to 25% by weight of metalaxyl-M, over the total weight of the composition, and
(c) from 40% to 85% by weight of said lactamide compound, and preferably from 50% to 80% by weight of said lactamide compound, over the total weight of the composition.

In the composition of the invention, R₁ and R₂ of the lactamide compound of formula I can be preferably each independently hydrogen or C₁ alkyl, and more preferably hydrogen or C₁₋₃ alkyl such as lactic acid dimethyl amide or lactic acid diethyl amide.

The composition of the present invention can further comprise one or several emulsifiers. More particularly, the composition can comprise from 0.01% to 40% by weight of emulsifier, preferably from 0.5% to 30% by weight of emulsifier, and more preferably from 0.5% to 20% by weight of emulsifier, over the total weight of the composition.

The emulsifiers can be surfactants well-known in the art, such as ionic (anionic, cationic or amphoteric) and non-ionic surfactants.

Suitable ionic surfactants are the alkali, alkaline earth and ammonium salts of aromatic sulfonic acids, for example of lignosulfonic acid, phenolsulfonic acid, naphthalenesulfonic acid, dibutylnaphthalenesulfonic acid or of fatty acids, alkyl- and alkylarylsulfonates, alkylsulfates, lauryl ether sulfates and fatty alcohol sulfates, and salts of sulfated hexa-, hepta- and octa-decanols, and of fatty alcohol glycol ethers, condensates of sulfonated naphthalene and its derivatives with formaldehyde, condensates of naphthalene or of the naphthalenesulfonic acids with phenol and formaldehyde, polycarboxylates, or phosphate esters of alkoxylated alcohols.

Suitable non-ionic surfactants are polyoxyethylene octyl phenol ethers, alkoxylated alcohols such as ethoxylated alkyl phenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, tristyrylphenol ethoxylates, polyoxyethylene alkyl ethers or polyoxypropylene alkyl ethers, lauryl alcohol polyglycol ether acetate, sorbitol esters, fatty acid ethoxylates, alkyl polyglucosides, lignin-sulfite waste liquors and also proteins, denatured proteins, polysaccharides (for example methylcellulose), hydrophobically modified starches, polyvinyl alcohols (for example Mowiol©), polyalkoxylates, polyvinylamines, polyethyleneimines, polyvinylpyrrolidones and their copolymers or block polymers.

In a preferred embodiment, the emulsifier can be selected among non-ionic surfactants. For example, the composition can comprise a sorbitol ester and a polyoxyalkylene copolymer, respectively in an amount from 1% to 20% by weight over the total weight of the composition. A preferred embodiment is a composition according to the invention comprising from 1% to 10% by weight of sorbitol ester and from 1% to 10% by weight of polyoxyalkylene copolymer, over the total weight of the composition

The sorbitol ester can be more particularly a polyoxyethylene sorbitan trioleate. For example, the sorbitol ester can be Tween 85, supplied by CRODA.

The polyoxyalkylene copolymer can be obtained from at least two different alkylene oxides, such as from ethylene oxide and propylene oxide monomers.

The polyoxyalkylene copolymer can be preferably a polyoxyalkylene block copolymer of the AB, ABA, BAB, or ABABA type.

More particularly, the polyoxyalkylene copolymer can be prepared by ring-opening polymerization of the corresponding cyclic ethylene oxide and propylene oxide monomers.

Typically, the ring-opening polymerization is initiated by addition of water and alkali hydroxides, such as sodium hydroxide and potassium hydroxide. The block structure of the copolymer is formed by first polymerizing a polymer block using one monomer, before adding a second monomer to form further polymer blocks.

In a preferred embodiment, the polyoxyalkylene copolymer can be an ethylene oxide-propylene oxide-ethylene oxide block copolymer (EO-PO-EO block copolymer), or in other words a poly(ethylene oxide)-poly(propylene oxide)-poly(ethylene oxide) block copolymer or a poly(ethylene glycol)-poly(propylene glycol)-poly(ethylene glycol) block copolymer.

In another preferred embodiment, the polyoxyalkylene copolymer can be an ethylene oxide-propylene oxide block copolymer (EO-PO block copolymer), or in other words a poly(ethylene oxide)-poly(propylene oxide) block copolymer or a poly(ethylene glycol)-poly(propylene glycol) block copolymer.

The polyoxyalkylene copolymer of the invention can have an average molecular weight from 1,000 to 15,000 g/mol, and preferably from 3,000 to 7,000 g/mol. Molecular weight of a polymer, or in other words the molar mass, can be easily determined by method well-known in the art, such as gel permeation chromatography (GPC).

Examples include the GENAPOL© PF series (CLARIANT), the PLURONIC© series (BASF), the SYNPERONIC© PE series (CRODA), or the TOXIMUL© series (STEPAN). As preferred example, the polyoxyalkylene copolymer can be a butyl polyalkylene oxide block copolymer, such as Toximul 8320 supplied by STEPAN.

The composition of the present invention can further comprise one or several dispersing agents. More particularly, the composition can comprise from 0.01% to 20% by weight of dispersing agent, and preferably from 0.5% to 10% by weight of dispersing agent, over the total weight of the composition.

In a preferred embodiment, the dispersing agent can be an acrylic graft copolymer.

The acrylic graft copolymer has typically a comb- or star-like structure, and preferably a comb-like structure.

Graft copolymers are branched copolymers wherein the components forming the side chains are structurally different from the components forming the main chain.

Comb-like polymers comprise of a main chain (backbone) which contains branch points from each of which a linear side chain emanates.

Star-like polymers comprise of a multifunctional centre from which at least three polymer chains radiate.

In a preferred embodiment, the acrylic graft copolymer can be an amphipathic copolymer.

More particularly, the acrylic graft copolymer comprises at least one component A, which is solvated by an aqueous medium (hydrophilic part), and at least one other component B which is hydrophobic.

Suitable acrylic graft copolymers may comprise polyethylene glycol, mono-methyl ethers of polyethylene glycol, poly(vinyl pyrrolidone), poly(acrylamide) or poly(vinyl alcohol) as hydrophilic side chain, while the hydrophobic backbone may comprise polymers and copolymers of styrene, methyl acrylate, methyl methacrylate, ethyl acrylate, 2-ethylhexyl acrylate, lauryl methacrylate, or vinyl acetate.

Such acrylic graft copolymers can for example be prepared by converting the monomethyl ether of a polyethylene glycol to the acrylic or methacrylic ester, which is then subjected to radical polymerization with other unsaturated monomers such as styrene, ethyl acrylate, or methyl methacrylate. It is also possible to prepare such acrylic graft copolymers by reacting a hydrophobic polymer backbone, which consists chemically reactive sites such as carboxyl, hydroxy, or amine groups, with monomeric alkylene oxides, such as ethylene oxide and propylene oxide, to form hydrophilic side chains.

More preferably, the acrylic graft copolymer is a non-ionic polymer, and more particularly with a comb-like structure.

In the present invention, the acrylic graft copolymer can comprise polyethylene glycol and/or mono-ether polyethylene glycol side chains.

The acrylic graft copolymer can also comprise a backbone obtained from acrylate and/or methacrylate monomers.

Even more preferably, the acrylic graft copolymer can comprise a backbone obtained from acrylate and/or methacrylate monomers, and side chains comprising polyethylene glycol and/or mono-ether polyethylene glycol, giving more particularly the polymer a comb-like structure.

For example, the acrylic graft copolymer can be Atlox 4913™ supplied by CRODA, or Tersperse 2500™ supplied by HUNTSMAN.

The composition of the invention can further comprise one or more formulation additives well-known in the art. In particular, the formulation additives can be selected among an anti-foam agent, a wetting agent, an anti-freeze agent, an anti-bacterial agent (or biocide), a viscosity modifier, a pH modifier, and any mixture thereof, and preferably the formulation additives can be selected among an anti-foam agent, a wetting agent, and any mixture thereof.

Each of the above-cited formulation additives can be added into the composition to obtain the desired property. For example, each of the formulation additives can be added into the composition in an amount from 0.0001% to 10% by weight, and preferably from 0.001% to 5% by weight, over the total weight of the composition.

Other suitable formulation additives include amongst others known to the person skilled in the art, antioxidant, colourant, perfume, adjuvant, attractant, binder, solid support (carrier), coating agent, deodorant, emetic agent, inorganic filler, safener, and any mixture thereof.

The composition of the present invention may further comprise an additional agrochemical. The additional agrochemical can be an insecticide, another fungicide, an herbicide, a synergist, a plant growth regulator, a nematicide, a plant nutrient, a plant fertilizer, and any mixture thereof.

The composition of the present invention may comprise a suitable amount of one or several of the above-mentioned ingredient(s) to obtain the respective properties, when appropriate.

According to the present invention, the composition can be advantageously used as a dispersible concentrate (DC) or as an emulsifiable concentrate (EC).

In a particular embodiment, the composition of the present invention may relate to:
a concentrate designed to be added to a farmer's spray tank of water or it may be applied directly without further dilution, or
a suspension produced in a farmer's spray tank of water when a concentrate is mixed with water in the spray tank.

Another object of the present invention relates to a method of controlling or preventing an infestation of plants by fungal organisms, which comprises the following applications of the composition according to the present invention: foliar application, soil application and/or tree injection.

In the foliar method or in the soil method, the composition of the present invention can be generally applied in spraying the composition, for example dispensed from a spray container.

Said soil or foliar method can involve an effective amount of the composition applied at a rate of from 0.01 to 5 Litre per Hectare (L/ha), and preferably from 0.02 to 3.0 L/ha.

Another object of the present invention relates to a use of the composition to control or prevent an infestation of plants by fungal organisms, especially against oomycete pathogens (e.g. Phytophthora species, downy mildews).

The plants can be selected among grapes, vegetables and permanent crops, and can be for example Cucurbitaceae (melon, watermelon, squash, pumpkin, zucchini, cucumber); Solanaceae (tomato, pepper, green tomato, eggplant); leafy vegetables (lettuce, chard, spinach, celery); Alliums (onion, green onion, garlic, leek); peas; Brassicaceae (broccoli, cauliflower, brussel sprouts, cabbage); grapes; pineapple; citrus; black pepper; cardamom; durian; avocado.

The following non-limiting examples demonstrate the improved behaviour associated with a composition according to the present invention.

The components used in the following examples are detailed as follows:
Oxathiapiprolin is a fungicide (CAS number: 1003318-67-9);
Metalaxyl-M is a fungicide (CAS number: 70630-17-0);
Lactic acid dimethyl amide (CAS number: 35123-06-9) is a lactamide compound of formula I used as solvent;
Dimethyl amide ether is methyl-5-(dimethylamino)-2-methyl-5-oxopentanoate (CAS number: 1174627-68-9) used as solvent;
Atlox 4913-LQ-(MV) is a solution comprising around 35% by weight of an acrylic graft copolymer, supplied by CRODA;
Toximul 8320 is a polyoxyalkylene copolymer (CAS Number: 9038-95-3), supplied by STEPAN;
Tween 85 is a sorbitol ester (CAS Number: 9005-70-3), supplied by CRODA;
Anti-foam agent is a polydimethylsiloxane; and
Wetting agent is dodecyl sulfate sodium salt.

### EXAMPLES

These examples provide a composition according to the present invention (Example 1) and a comparative example (Example 2), which are dispersible concentrates (DC).

Each sample was prepared by mixing the individual ingredients together, then by gently warming around 35° C., and by stirring the mixture until a uniform solution was achieved, which was then allowed to cool to room temperature (20° C.).

The concentrations of the components added to form the compositions of Example 1 (Ex. 1) and Example 2 (Ex. 2) are listed in the below Table 1, and are expressed in percentage by weight over the total weight of the composition (% w/w).

The composition according to the present invention (Ex. 1) includes 2.8% by weight of oxathiapiprolin, 16.8% by weight of metalaxyl-M and around 65.1% by weight of lactamide compound of formula I as solvent, over the total weight of the composition, while the comparative example (Ex. 2) mainly includes less amount of metalaxyl-M and a different solvent.

TABLE 1

| | Ex. 1 | Ex. 2 |
|---|---|---|
| Component | (% w/w) | (% w/w) |
| Oxathiapiprolin | 2.8 | 3.2 |
| Metalaxyl-M | 16.8 | 9.8 |
| Atlox 4913-LQ-(MV) | 5.8 | 5.8 |
| Toximul 8320 | 4.7 | 4.7 |
| Tween 85 | 4.7 | 4.7 |
| Anti-foam agent | 0.005 | 0.005 |
| Wetting agent | 0.09 | 0 |
| Lactic acid dimethyl amide | ad 100 (rest) | 0 |
| Dimethyl amide ether | 0 | ad 100 (rest) |

Then different properties were determined to show the effects according to the present invention, such as the temperature stability at −10° C. as well as the eye irritancy.

To evaluate the temperature stability at −10° C. of the samples (Ex. 1 and 2), subsamples were put on storage in a temperature-controlled cabinet set at −10° C. The appearance of the sub-samples is then checked at regular intervals over several weeks (up to 12 weeks) for signs of crystallisation and/or sedimentation and/or separation. A cold stability is considered as good when the sub-samples remain homogenous and unchanged at the end of the storage period at −10° C.

To evaluate the eye irritancy of samples (Ex. 1 and 2), eye irritation studies were performed according to OECD Test Guideline 405 (TG 405) and the category classification was based on the Globally Harmonized System of Classification and Labelling of Chemicals (GHS).

According to GHS, Category 1 (Cat. 1) means there is serious eye damage on the eye, while category 2 (Cat. 2) means there is a potential to induce reversible eye irritation, so that Cat. 2 is less adverse than Cat. 1. Category 2 is sub-divided into category 2A (Cat. 2A) and category 2B (Cat. 2B), wherein Cat. 2B is considered as mildly irritating to eyes, so that Cat. 2B is less adverse than Cat. 2A.

All the results of temperature stability and eye irritancy classification are gathered in Table 2.

TABLE 2

| Results | Ex. 1 | Ex. 2 |
|---|---|---|
| Temperature stability (−10° C.) | Good | Good |
| Eye irritancy classification | Cat. 2B | Cat. 1 |

The results obtained from Example 1 guarantee a good cold stability at −10° C., while providing a low eye irritancy (Cat. 2B), especially in view of a high loading of active ingredients.

1. A fungicidal composition comprising:
(a) oxathiapiprolin,
(b) metalaxyl-M, and
(c) a lactamide compound of formula I
CH₃CH(OH)C(═O)NR₁R₂ (I)
wherein R₁ and R₂ are each independently hydrogen; or C₁₋₆ alkyl, C₂₋₆ alkenyl or C₃₋₆ cycloalkyl, each of which is optionally substituted by up to three substituents independently selected from phenyl, hydroxy, C₁₋₅ alkoxy, morpholinyl and NR₃R₄ where R₃ and R₄ are each independently C₁₋₃ alkyl; or phenyl optionally substituted by up to three substituents independently selected from C₁₋₃ alkyl; or R₁ and R₂ together with the nitrogen atom to which they are attached form a morpholinyl, pyrrolidinyl, piperidinyl or azepanyl ring, each of which is optionally substituted by up to three substituents independently selected from C₁₋₃ alkyl,
the composition comprising at least 40% by weight of said lactamide compound, over the total weight of the composition.

2. A composition according to claim 1, characterized in that the composition comprising at least 50% by weight of said lactamide compound, and preferably at least 60% by weight of said lactamide compound, over the total weight of the composition.

3. A composition according to claim 1, characterized in that the composition comprises at least 5% by weight of metalaxyl-M, and preferably at least 10% by weight of metalaxyl-M, over the total weight of the composition.

4. A composition according to claim 1, characterized in that the composition comprises:
(a) from 1% to 10% by weight of oxathiapiprolin, over the total weight of the composition,
(b) from 5% to 30% by weight of metalaxyl-M, over the total weight of the composition, and
(c) from 40% to 85% by weight of said lactamide compound, over the total weight of the composition.

5. A composition according to am claim 1, characterized in that R₁ and R₂ are each independently hydrogen or C₁₋₆ alkyl.

6. A composition according to claim 1, characterized in that the composition further comprises one or several emulsifiers.

7. A composition according to claim 6, characterized in that the composition comprises from 0.01% to 40% by weight of emulsifier, preferably from 0.5% to 30% by weight of emulsifier, and more preferably from 0.5% to 20% by weight of emulsifier, over the total weight of the composition.

8. A composition according to claim 1, characterized in that the composition further comprises one or several dispersing agents.

9. A composition according to claim 8, characterized in that the composition comprises from 0.01% to 20% by weight of dispersing agent, and preferably from 0.5% to 10% by weight of dispersing agent, over the total weight of the composition.

10. A composition according to claim 1, characterized in that the composition is a dispersible concentrate or an emulsifiable concentrate.

11. A method of controlling or preventing an infestation of plants by fungal organisms, which comprises the foliar and/or the soil application(s) of the composition according to claim 1.

12. A method according to claim 11, characterized in that the plant is selected among grapes, vegetables and permanent crops.

13. Use of a composition according of claim 1 to control or prevent an infestation of plants by fungal organisms.
